(19) United States
(12) Patent Application Publication
(10) Pub. No.: US 2003/0178555 A1
(43) Pub. Date: Sep. 25, 2003

(54) Filtering method and mechanism for scanners

(75) Inventor: Po-Hua Fang, Taipei (TW)

Correspondence Address: Dougherty &Troxell, Suite 1404, 5205 Leesburg Pike, Falls Church, VA, 22041, US

(73) Assignee: UMAX DATA SYSTEMS INC., Hsinchu (TW)

(21) Appl. No.: 10/391,593

(22) Filed: Mar. 20, 2003

Related U.S. Application Data
(62) Division of application No. 09/690,760, filed on Oct. 18, 2000, now abandoned.

(30) Foreign Application Priority Data
Jun. 20, 2000 (TW) 89112585

(51) Int. Cl. G01J 3/50

(52) U.S. Cl. 250/226

(57) ABSTRACT

A filtering method and mechanism for scanners includes a regular visible light source and an infrared light source that are both turned on under a scanner normally on state during scanning operation. A transmission mechanism is provided for reciprocally placing a visible light filter plate and an infrared light filter plate in the scanner light path to filter light emitting from the regular visible light and infrared light source. Changing and switching between regular and infrared light scanning may be done quickly without warm up delay of the light source. More versatile and powerful function thus may be built in the scanner.

### FIELD OF THE INVENTION

This invention relates to a novel filtering method and mechanism for scanners and particularly to a filtering method and mechanism that enable both visible and infrared light source always turned on and ready for use in the scanners.

### BACKGROUND OF THE INVENTION

Scanner is a widely used computer peripheral device nowadays. Many techniques have been developed to expand scanner function and utilization. Infrared light scanning technique is one of them that is being frequently used for repairing image defects. When in use, scanner regular visible light and repairing infrared light are originated from two different light sources. Infrared light scanning is used for detecting image defects for repairing use. U.S. Pat. No. 5,266,805 (Titled: System and Method for Image Recovery) is another example which uses infrared red light to detect film defects such as dust, speck, finger print and the likes, or bubbles and netting traces formed in the emulsion layer of the film. Once the defects are detected, they may be removed or repaired by means of various computer image process techniques known in the arts. In the conventional methods and techniques mentioned above, the scanner regular light and infrared light are come from two different light sources and should be turned on at different time. That creates operational problems.

FIG. 1 shows a conventional technique being used in the prior art. During normal and regular scanning operation, a visible scanning light source 20 is powered on to project light to the scanning document 10. The scanning image light then reflects a number of times in a reflection means which may include a plurality of reflection mirrors 40,50,60 and 70 before entering into the lens 80, and finally projects upon a Charged Couple Device (CCD) 90 for image process. When there is an image repairing job required, a separated infrared light source 30 will be powered on for another cycle of scanning. Infrared light path is essentially same as the scanning light path for the visible light set forth above.

The power on and readiness of the infrared light source needs warm up time. During this warm up time period, the scanner is idle. When infrared light scanning process is finished and the scanner is returned to regular scanning operation, another warm up time is needed for the visible scanning light source. This causes productivity drop for both operator and the scanner. There is room for improvement in this respect.

### SUMMARY OF THE INVENTION

It is an object of this invention to provide a filtering method and mechanism that enable both visible and infrared light source always under a normally on state and ready for use in the scanner so that warm up tine for the scanner may be cut to minimum level. Scanner function thus may be enhanced. Scanner utilization and operator productivity may also be increased.

In one aspect, this invention has the visible and infrared light sources powered on at the same time during scanner operation. A filtering mechanism is provided to allow the needed light (such as infrared light) to travel the light path for a required scanning operation while another light (such as visible light) will be filtered out from reaching the scanning light path. When situation is changed and scanning light should also be changed, the filtering mechanism may switch a different light source (such as visible light) to the scanning path while the not required light (such as infrared light) is filtered out from reaching the scanning light path. This change and switch may be accomplished instantly without warm up delay.

For achieving aforesaid object, this, invention provides a reciprocal transmission mechanism in the scanner for driving the filtering mechanism. It includes a motor as the driver, a screw nut attached with a rod for holding filter plates and a screw bar engageable with the screw nut and driven by the motor for the filter plates be moving reciprocally over two different light sources so that only one type of light will reach the light path of the scanner during scanning operation. The filter plates include a visible light filter plate and an infrared red light filter plate.

In another aspect, the reciprocal transmission mechanism is an electromagnetic switch means for replacing the motor, screw bar and nut.

In a further aspect, the filtering mechanism may be located between the scanning document and reflection means, or be located between the lens and reflection means, or other location in the scanning light path.

In yet another, aspect, the method of this invention may include initially setting both the visible and infrared light sources at a power on state, then moves the scanner chassis to a selected position to start scanning operation using visible light to get an image which will be stored. Then the filtering mechanism is actuated for infrared light scanning to obtain required data which will also being stored. Thereafter, defect data is included for determining repairs needed on the image. This operation cycle may be repeated until all scanning jobs are finished.

### BRIEF DESCRIPTION OF THE DRAWINGS

The invention, as well as its many advantages, may be further understood by the following detailed description and drawings, in which:

FIG. 1 is a schematic view of a light path for a conventional scanner which uses two light sources.

FIG. 2 is a schematic view of a light path for an embodiment of this invention.

FIG. 3 is a fragmentary side view of a filtering mechanism of this invention.

FIG. 4 is a schematic view of another embodiment of this invention which uses an electromagnetic switch means as the driver.

FIG. 5 is yet another embodiment of this invention with the filtering mechanism being placed at a different location in the light path of the scanner.

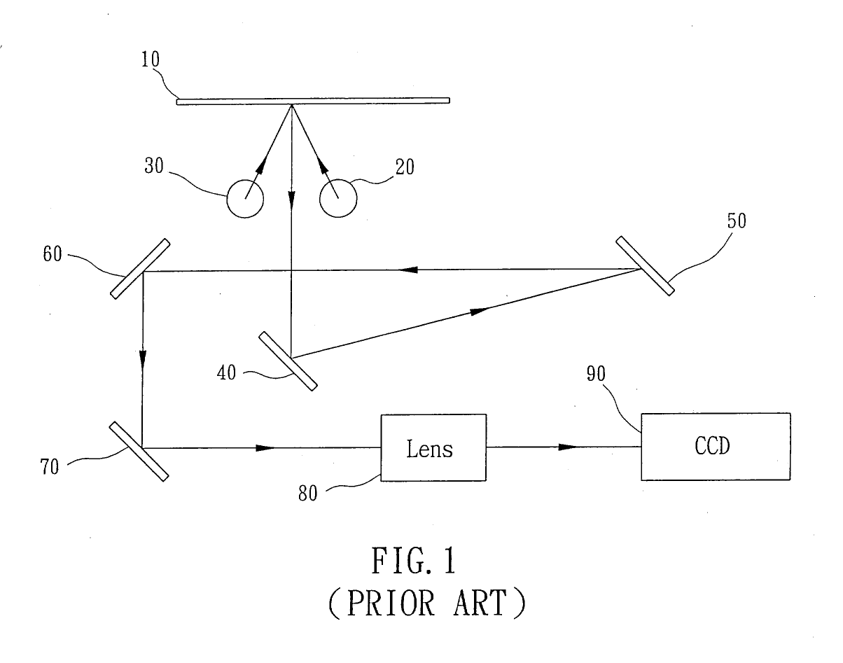

### DETAILED DESCRIPTION OF THE PREFERRED EMBODIMENT

This invention aims at providing a filtering method and mechanism that combines the filter plates and a reciprocal transmission mechanism for a scanner to perform more powerful function conveniently.

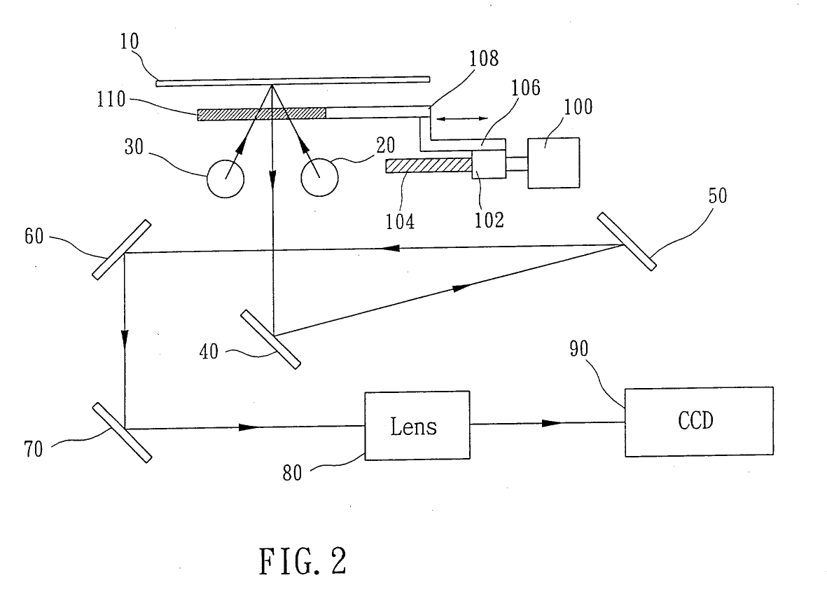

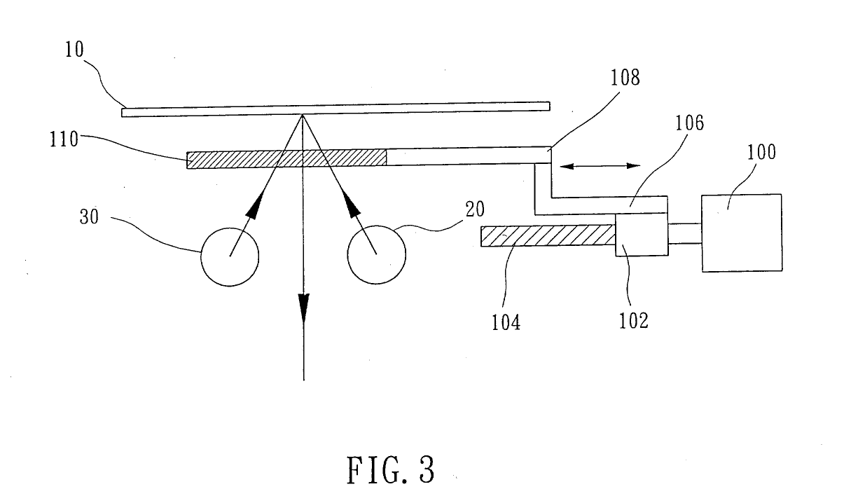

FIGS. 2 and 3 show a general structure of this invention. Light path for the scanner in this invention is largely like a conventional one. There are two light sources, a first light source 20 for visible light and a second light source 30 for infrared light. Both the first and second light source 20 and 30 may emit light to a scanning document 10. Then image light will be reflected to a reflecting means which may include a first reflection mirror 40, a second reflection mirror 50, a third reflection mirror 60 and a fourth reflection mirror 70. Next, the image light will enter into a lens 80 and projects to a Charged Couple Device (CCD) 90 for process. However this invention includes a filtering mechanism between the scanning document 10 and light sources 20 and 30. The filtering mechanism includes a first filter plate 108 for visible light by filtering out light of wave length outside the range of 400-700 nm, a second filter plate 110 for infrared light by filtering out light of wave length beyond 820-890 nm, and a transmission mechanism which has a motor 100 driving a screw bar 104. The screw bar 104 engages with a screw nut 102 which attaches to a rod 106 for holding the first and second filter plate 108 and 110. When in use, both the first and second light source 20 and 30 are powered on concurrently. When visible light scanning is required at the initial stage, the transmission mechanism will be set at a selected location and places the first filter plate 108 in the light path for receiving light from the visible light source 20. When infrared light scanning is desired, the motor 100 will be actuated to move the second filter plate 110 in the light path for receiving infrared light from the infrared light source 30. As the first and second light source 20 and 30 are all being turned on during scanning operation time, change and switch of visible light scanning and infrared light scanning may be done quickly with no warm up time needed. The moving and switching of the filter plates may be done by the transmission mechanism quickly. The productivity loss due to change of filter plate may be greatly reduced. Instead of motor and screw set, other transmission mechanism such as belt, steel wire, gear and gear rack may also be used.

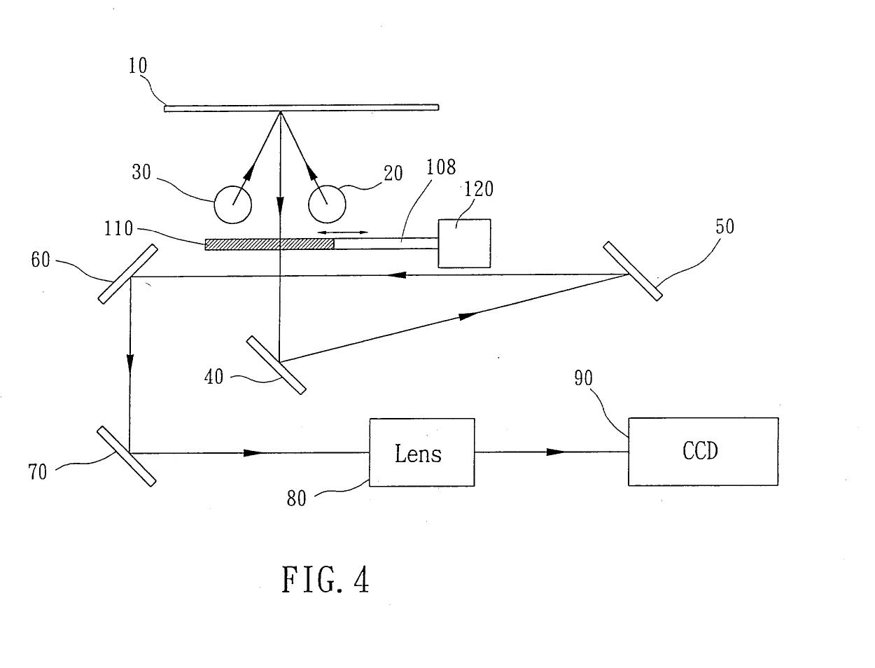

FIG. 4 shows another embodiment of this invention. It is largely constructed like the one shown in FIG. 2. However an electromagnetic switch 120 is used to replace the motor and screw set as the transmission mechanism.

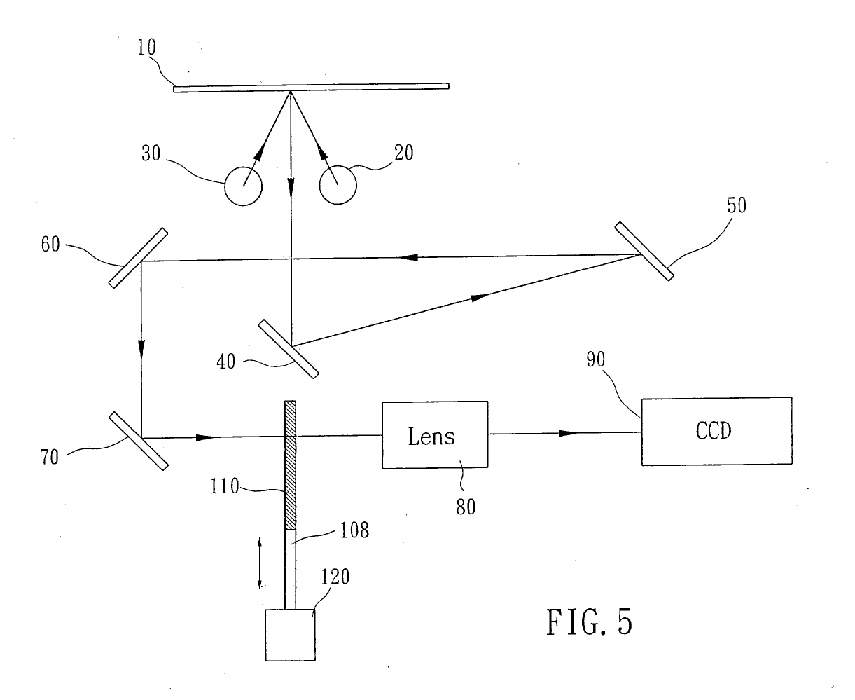

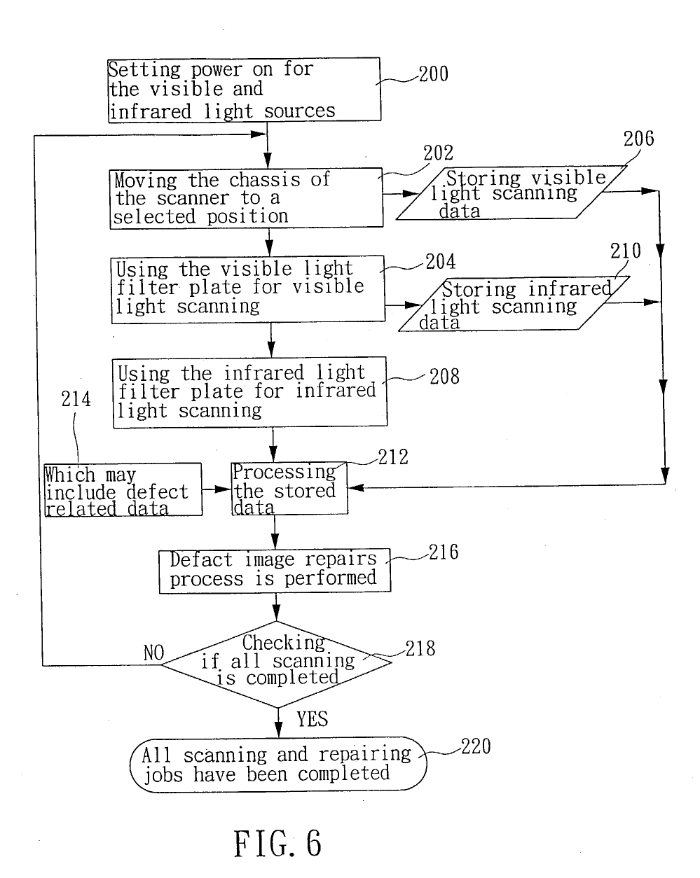

There are many choices for the location of the filter mechanism. FIGS. 2 and 4 show one embodiment which places the filter mechanism between the scanning document 10 and light sources 20 and 30. FIG. 5 shows another embodiment which places the filter mechanism between the reflection mirror 70 and lens 80

FIG. 6 shows a general process flow of the method used in this invention. It starts by setting power on for the visible and infrared light sources 200, then moving the chassis of the scanner to a selected position 202, using the visible light filter plate for visible light scanning 204, storing visible light scanning data 206, then activating the filter mechanism and using the infrared light filter plate for infrared light scanning 208, storing infrared light scanning data 210. Then processing the stored data 212 which may include defect related data 214. Then defect image repairs process is performed 216. Afterward, checking if all scanning is completed 218. The process ends when all scanning and repairing jobs have been completed 220, otherwise the process branches out to the step 202 for another cycle of scanning operation.

Through the method and mechanism of this invention, normal and infrared light scanning may be changed and switched in a very short time without warm up delay. Scanner function and versatility may be improved, scanner utilization and operator productivity may be greatly enhanced.

It may thus be seen that the objects of the present invention set forth herein, as well as those made apparent from the foregoing description, are efficiently attained. While the preferred embodiments of the invention have been set forth for purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A filter mechanism for a scanner, comprising:
a reciprocal transmission mechanism for moving a filter plate to receive light from a visible light source and an infrared light source, both the visible light source and infrared light source being turned on and ready at a scanner normal on state during scanning operation without need for warm up.

2. The filter mechanism for a scanner of claim 1, wherein the reciprocal transmission mechanism including:
a screw bar,
a screw nut engageable with the screw bar and attached to a rod for holding the filter plate, and
a motor for driving the screw bar to move the screw nut and filter plate reciprocally.

3. The filter mechanism for a scanner of claim 1, wherein the filter plate includes a first filter plate for filtering visible light and a second filter plate for filtering infrared light.

4. The filter mechanism for a scanner of claim 1, wherein the reciprocal transmission mechanism is an electromagnetic switch means.

5. The filter mechanism for a scanner of claim 1, wherein the filter mechanism is located in a light path of the scanner between a scanning document and a reflection means of the scanner.

6. The filter mechanism for a scanner of claim 1, wherein the filter mechanism is located in a light path of the scanner between a lens and a reflection means of the scanner.

7. A filter mechanism for a scanner located in a light path of the scanner, comprising:
a first filter plate for filtering visible light,
a second filter plate for filtering infrared light,
a screw bar,
a screw nut engageable with the screw bar,
a rod attached to the screw nut for holding the first and second filter plate, and
a motor for driving the screw bar to move the screw nut and the rod for moving the first and second filter plate reciprocally in the light path.

8. The filter mechanism for a scanner of claim 7, wherein the filter mechanism is located between a scanning document and a reflection means of the scanner.

9. The filter mechanism for a scanner of claim 7, wherein the filter mechanism is located between a lens and a reflection means of the scanner.

10. A filter mechanism for a scanner located in a light path of the scanner, comprising:
a first filter plate for filtering visible light,
a second filter plate for filtering infrared light, and
an electromagnetic switch means for holding the first and second filter plate and reciprocally moving the filter mechanism.

11. The filter mechanism for a scanner of claim 10, wherein the filter mechanism is located between a scanning document and a reflection means of the scanner.

12. The filter mechanism for a scanner of claim 10, wherein the filter mechanism is located between a lens and a reflection means of the scanner.

13. A filtering method for a scanner, comprising the following steps:
a. turning on a regular light source and an infrared light source concurrently,
b. moving a chassis to a selected position,
c. using a regular light filter to filter light emitting from the regular light source for regular scanning operation, and storing regular scanning data,
d. using an infrared light filter to filter infrared light emitting from the infrared light source for infrared light scanning operation, and storing infrared light scanning data,
e. processing the storing data,
f. comparing the storing data with defect data originated from the regular scanning operation, and
g. returning to the step b until all scanning operation is finished.

14. The filtering method for a scanner of claim 13, wherein the step e further includes adding required defect data for comparing use at the step f.
